(19) United States
(12) Patent Application Publication
(10) Pub. No.: US 2014/0295198 A1
(43) Pub. Date: Oct. 2, 2014

(54) Coating Materials Comprising Glycerol Diesters And Use Thereof In Multicoat Paint Systems

(71) Applicant: BASF Coatings GmbH, Münster (DE)

(72) Inventors: Peter Hoffmann, Senden (DE); Sebastien Porcher, Ludwigshafen (DE); Jean-Francois Stezycki, Nogent/Oise (FR)

(21) Appl. No.: 14/358,379

(22) PCT Filed: Nov. 16, 2012
(86) PCT No.: PCT/EP2012/072879

§ 371 Date: May 15, 2014

Related U.S. Application Data
(60) Provisional application No. 61/560,860, filed on Nov. 17, 2011.

(30) Foreign Application Priority Data
Nov. 17, 2011 (EP) 11189617.1

(51) Int. Cl. C09D 133/08; B05D 7/00

(52) U.S. Cl. CPC C09D 133/08; B05D 7/572
USPC 428/523; 524/558; 427/385.5; 427/327; 427/457; 427/393.5

(57) ABSTRACT

Described are coating materials comprising (a) at least one polymeric polyol selected from the group consisting of poly(meth)acrylate polyols, polyester polyols, polyurethane polyols and polysiloxane polyols, (b) at least one crosslinking agent selected from the group consisting of blocked and nonblocked polyisocyanates, amino resin crosslinkers, and TACT, and (c) at least one glycerol diester of the general formula (I)

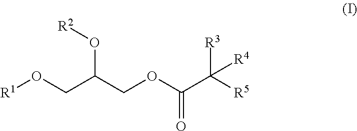

wherein one of the two radicals R¹ or R² is hydrogen and the radical of the two radicals R¹ and R² that is not hydrogen is a radical

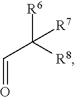

the radicals R³, R⁴, R⁵, R⁶, R⁷, and R⁸ independently of one another are hydrogen or a saturated, aliphatic radical having 1 to 20 carbon atoms, with the proviso that the radicals R³, R⁴ and R⁵ together contain at least 5 carbon atoms and the radicals R⁶, R⁷ and R⁸ together contain at least 5 carbon atoms. Also described are multicoat paint systems and their production, the use of the coating materials, and substrates coated therewith.

### CROSS-REFERENCE TO RELATED APPLICATIONS

This application is the National State entry of PCT/EP2012/072879, filed on Nov. 16, 2012, which claims priority to U.S. Provisional Application Ser. No. 61/560,860, filed on Nov. 17, 2011 and European Patent Application No. 11189617.1, filed on Nov. 17, 2011, the disclosures of which are incorporated herein by reference in their entireties.

### TECHNICAL FIELD

The present invention relates to coating material compositions comprising glycerol diesters and also to multicoat paint systems obtained using the coating material compositions, and to a method for producing such multicoat paint systems, and to substrates coated therewith.

### BACKGROUND

There is a steady demand for coating materials which while having the same solids content as their conventional counterparts can be applied in lower film thicknesses and lead to an equal or even better appearance, including in particular to outstanding leveling of the coatings. Coating materials of this kind could make a critical contribution to reducing the quantities of coating material used industrially, especially in the finishing of motor vehicles. From an economic standpoint, therefore, they are advantageous and also contribute to environmental protection. In the finishing of motor vehicles as well, in particular, it is desirable to provide coating materials which for the same film thickness as their conventional counterparts lead to a good appearance at those locations on the vehicle body at which geometry dictates that the film thicknesses obtainable are low.

It is particularly desirable to provide coating materials which manage, furthermore, with a low level of volatile organic compounds (VOCs for short).

Thus, coating material compositions which enhance the appearance of the cured coating material and ensure effective leveling of the coating material, and which possess in particular a comparatively low VOC content are desired.

EP 1 717 281 A1 discloses aqueous floor coating compositions which comprise monoesters or diesters of a triol with an aliphatic C7-C10 monocarboxylic acid Likewise disclosed are said monoesters or diesters as constituents of leveling agents or plasticizers.

### SUMMARY

A first aspect of the present invention is directed to a coating material composition. In a first embodiment, a coating material composition comprises (a) at least one polymeric polyol selected from the group consisting of poly(meth)acrylate polyols, polyester polyols, polyurethane polyols and polysiloxane polyols, (b) at least one crosslinking agent selected from the group consisting of blocked and nonblocked polyisocyanates, amino resin crosslinkers, and TACT, and (c) at least one glycerol diester of the general formula (I)

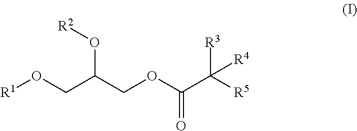

wherein one of the two radicals R¹ or R² is hydrogen and the radical of the two radicals R¹ and R² that is not hydrogen is a radical

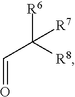

And the radicals R³, R⁴, R⁵, R⁶, R⁷ and le independently of one another are hydrogen or a saturated, aliphatic radical having 1 to 20 carbon atoms, with the proviso that the radicals R³, R⁴ and R⁵ together contain at least 5 carbon atoms and the radicals R⁶, R⁷ and le together contain at least 5 carbon atoms.

In a second embodiment, the coating material composition of the first embodiment is modified, wherein R¹ is hydrogen.

In a third embodiment, the coating material composition of the first embodiment is modified, wherein R² is hydrogen.

In a fourth embodiment, the coating material composition of the first through third embodiments is modified, wherein the radicals R³, R⁴ and R⁵ together contain 5 to 11 carbon atoms and the radicals R⁶, R⁷ and R⁸ together contain 5 to 11 carbon atoms.

In a fifth embodiment, the coating material composition of the first through fourth embodiments is modified, wherein component (a) comprises at least one poly(meth)acrylate polyol or polyester polyol.

In a sixth embodiment, the coating material composition of the first through fifth embodiments is modified, wherein component (b) comprises at least one blocked or nonblocked polyisocyanate.

In a seventh embodiment, the coating material composition of the first through sixth embodiments is modified, wherein the coating material composition is a clearcoat material.

In an eighth embodiment, the coating material composition of the first through seventh embodiments is modified, wherein the hydroxyl number of component (a) differs by not more than 50% from the hydroxyl number of the glycerol diester component (c) used in the coating material composition, and/or the fraction of the glycerol diester component (c) is 2% to 20% by weight, based on the total weight of components (a) plus (c).

A second aspect of the present invention is directed to a multicoat paint system. In a ninth embodiment, a multicoat paint system comprises at least two coats disposed on a substrate, wherein the uppermost coat of the coats consists of the coating material composition the first through eighth embodiments.

A third aspect of the present invention is directed to a method for producing a multicoat paint system. In a tenth embodiment, a method of producing a multicoat paint system comprises the following steps: (i) applying applying a primer-surfacer coating material to an untreated or pretreated substrate and/or (ii) applying at least one basecoat composition thereto and subsequently (iii) applying at least one coating composition according the first through eighth embodiments, followed by (iv) curing of the multicoat paint system at a temperature of (1) up to 100° C. maximum, where the crosslinking agent (b) is a nonblocked polyisocyanate, or (2) from 120° C. to 180° C., where the crosslinking agent (b) comprises at least one blocked polyisocyanate, an amino resin crosslinker or TACT.

In an eleventh embodiment, the method of the tenth embodiment is modified, wherein the substrate in step (i) is a pretreated metallic substrate and the pretreatment comprises a phosphatizing and/or cathodic electrode position coating treatment or the substrate in step (i) is a plastics substrate.

In a twelfth embodiment, the method of the tenth and eleventh embodiments is modified, wherein in step (iii) the coating composition of the fifth embodiment is used.

In a thirteenth embodiment, the method of the tenth through twelfth embodiments is modified, wherein in step (iii) the coating composition of the seventh embodiment is used.

In a fourteenth embodiment, the method of the tenth through thirteenth embodiments is modified, wherein the substrate in step (i) is an automotive bodywork or a part of an automotive bodywork.

An additional aspect of the present invention is directed to a substrate. A fifteenth embodiment is directed to a substrate that has been coated with the multicoat paint system of the ninth embodiment.

A sixteenth embodiment is directed to a substrate that has been coated by the method of the tenth through fourteenth embodiments.

### DETAILED DESCRIPTION

Provided are new coating material compositions comprising
(a) at least one polymeric polyol selected from the group consisting of poly(meth)acrylate polyols, polyester polyols, polyurethane polyols and polysiloxane polyols,
at least one crosslinking agent selected from the group consisting of blocked and nonblocked polyisocyanates, amino resin crosslinkers, and TACT, and
(b) at least one glycerol diester of the general formula (I)

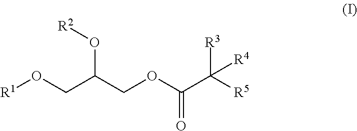

wherein
one of the two radicals R¹ or R² is hydrogen and the radical of the two radicals R¹ and R² that is not hydrogen is a radical

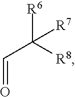

and
the radicals R³, R⁴, R⁵, R⁶, R⁷ and R⁸ independently of one another are hydrogen or a saturated, aliphatic radical having 1 to 20, specifically 1 to 10, carbon atoms,
   with the proviso that the radicals R³, R⁴ and R⁵ together contain at least 5 carbon atoms and the radicals R⁶, R⁷ and R⁸ together contain at least 5 carbon atoms.

In one particular embodiment, R¹ is hydrogen. In another particular embodiment, R² is hydrogen.

The joint number of carbon atoms in the radicals R³, R⁴ and R⁵, and the joint number of the carbon atoms in the radicals R⁶, R⁷ and R⁸, is specifically not more than 20, more specifically 5 to 11 and very specifically 5 to 9.

In one or more embodiments, aside from the above proviso, the radicals R³, R⁴, R⁵, R⁶, R⁷, and R⁸ independently of one another are hydrogen or alkyl radicals having 1 to 10, more specifically 1 to 8 and very specifically 1 to 6 carbon atoms. These alkyl radicals may be substituted or unsubstituted and, in specific embodiments, are unsubstituted. These alkyl radicals may be linear or branched, and where R³=R⁴=R⁶=R⁷=H, the radicals R⁵ and R⁸ are alkyl radicals featuring at least one branching.

Where these alkyl radicals are substituted, in one or more embodiments, substituents present are one or more radicals selected from the group consisting of hydroxyl, O(CO)ₙR⁹ groups with n=0 or 1 and R⁹=branched or unbranched alkyl having 1 to 6 carbon atoms, and aliphatic radicals containing ether groups and/or ester groups and having 1 to 10, specifically 2 to 10, carbon atoms.

In one or more embodiments, at least two of the radicals R³, R⁴ and R⁵ and also two of the radicals R⁶, R⁷ and R⁸ are alkyl radicals having 1 to 7 carbon atoms. In specific embodiments, at least one of the radicals R³, R⁴ and R⁵ is an alkyl radical having 1 to 3 carbon atoms, and another of the radicals R³, R⁴ and R⁵ is an alkyl radical having at least 4 carbon atoms, and also one of the radicals R⁶, R⁷ and R⁸ is an alkyl radical having 1 to 3 carbon atoms and another of the radicals R⁶, R⁷ and R⁸ is an alkyl radical having at least 4 carbon atoms.

In one especially preferred embodiment the total number of carbon atoms in the radicals R³, R⁴ and R⁵ together is 6 to 10, specifically 8, and that of the radicals R⁶, R⁷ and R⁸ is likewise 6 to 10, specifically 8.

In the text below, the coating material composition of the invention is also referred to for short as “coating material of the invention”.

A “polymeric polyol” herein means a polyol having at least two hydroxyl groups, and the term “polymeric” herein also encompasses the term “oligomeric”. Oligomers herein consist of at least three monomer units.

The preferred polymeric polyols (a) have weight-average molecular weights M_{w}>500 daltons as measured by GPC (gel permeation chromatography) against a polystyrene standard, specifically of 800 to 100 000 daltons, more particularly of 1000 to 50 000 daltons. Great preference attaches to those having a weight-average molecular weight of 1000 to 10 000 daltons.

In one or more embodiments, the polymeric polyols (a) have a hydroxyl number (OH number) of 30 to 400 mg KOH/g, more particularly of 100 to 300 mg KOH/g, and very specifically 120 to 180 mg KOH/g.

In one specific embodiment of the coating material composition of the invention the OH number of the polymeric polyol (a) or of the mixture of polymeric polyols (a) differs by not more than 50%, more specifically not more than 40% and very specifically not more than 20%, from the OH number of the glycerol diester component (c) used in the coating material composition.

In one or more embodiments, the glass transition temperatures of the polymeric polyols (a), measured by DSC (differential scanning calorimetry, TA Instruments DSC 1000 from Waters GmbH, Eschborn, Germany; heating rate 10° C./minute), are between −150 and 100° C., more specifically between −120° C. and 80° C.

The term “poly(meth)acrylate” comprehends not only polyacrylates but also polymethacrylates, and also polymers which comprise not only methacrylates and/or methacrylic acid but also acrylates and/or acrylic acid. Besides acrylic acid, methacrylic acid and/or the esters of acrylic acid and/or methacrylic acid, the poly(meth)acrylates may also comprise other ethylenically unsaturated monomers. In one or more embodiments, the monomers from which the poly(meth)acrylates are obtained are monoethylenically unsaturated monomers. A “poly(meth)acrylate polyol means a poly(meth)acrylate which contains at least two hydroxyl groups.

Instead of or in addition to the poly(meth)acrylate polyols it is also possible to use polyester polyols. A polyester polyol here is a polyester which carries at least two hydroxyl groups.

Where poly(meth)acrylate polyols and polyester polyols are used jointly, both components may be prepared individually or by polymerizing the poly(meth)acrylate polyol in situ in a polyester polyol component or a solution thereof in suitable solvent.

Especially preferred among the polymeric polyols are polyacrylate polyols and/or polymethacrylate polyols and also copolymers thereof. They may be prepared in a single stage or two or more stages. They may take the form, for example, of random polymers, gradient copolymers, block copolymers or graft polymers.

In one or more embodiments, the poly(meth)acrylate polyols especially preferred in accordance with the invention are generally copolymers with other vinylically unsaturated monomers, and have weight-average molecular weights M_{w} of 1000 to 20 000 g/mol, more particularly of 1500 to 10 000 g/mol, measured in each case by means of gel permeation chromatography (GPC) against a polystyrene standard.

The glass transition temperature of the poly(meth)acrylate polyols is generally between −100 and 100° C., more particularly between −50 and 80° C. (measured by means of DSC measurements, as indicated above).

In one or more embodiments, the poly(meth)acrylate polyols have an OH number of 60 to 250 mg KOH/g, more particularly 70 to 200 KOH/g, and very specifically 120 to 180 mg KOH/g. In one or more embodiments, their acid number is 0 to 30 mg KOH/g.

The hydroxyl number indicates the number of mg of potassium hydroxide that are equivalent to the amount of acetic acid bound by 1 g of solid substance on acetylation. For the determination, the sample is boiled with acetic anhydride-pyridine and the resultant acid is titrated with potassium hydroxide solution (DIN 53240-2).

The acid number herein indicates the number of mg of potassium hydroxide consumed in neutralizing 1 g of the compound in question (DIN EN ISO 2114).

As hydroxyl-containing monomer units of the poly(meth)acrylate polyols it is preferred to use one or more hydroxyalkyl (meth)acrylates, such as, in particular, 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate, and also, in particular, 4-hydroxybutyl acrylate and/or 4-hydroxybutyl methacrylate. In particular it is also possible with advantage to use mixtures which are a result of the industrial preparation. Thus, for example, industrially prepared hydroxypropyl methacrylate is composed of about 20%-30% 3-hydroxypropyl methacrylate and 70%-80% 2-hydroxypropyl methacrylate.

As further monomer units for the synthesis of the poly(meth)acrylate polyols it is preferred to use alkyl (meth)acrylates, such as, specifically, ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate, or, in particular cyclohexyl acrylate and/or cyclohexyl methacrylate.

As further monomer units for the synthesis of the poly(meth)acrylate polyols it is possible to use vinylaromatic hydrocarbons, such as vinyltoluene, alpha-methylstyrene or, in particular styrene, amides or nitriles of acrylic or methacrylic acid, vinyl esters or vinyl ethers, and also, in minor amounts, in particular, acrylic acid and/or methacrylic acid.

Suitable polyester polyols are described in EP-A-0 994 117 and EP-A-1 273 640, for example. Suitable polyester polyols may be obtained in particular, as is known to a person of ordinary skill in the art, through polycondensation from polyols and polycarboxylic acids or their anhydrides.

As polyol or polyol mixture which can be used in the polycondensation reaction, suitability is possessed more particularly by polyhydric alcohols and/or mixtures thereof, the alcohols having at least two, specifically at least three, hydroxyl groups. The polyol or polyol mixture used specifically comprises at least one higher polyfunctional polyol which has at least three hydroxyl groups. Suitable higher polyfunctional polyols having at least three hydroxyl groups are specifically selected from the group consisting of trimethylolpropane (TMP), trimethylolethane (TME), glycerol, pentaerythritol, sugar alcohols, ditrimethylolpropane, dipentaerythritol, diglycerol, trishydroxyethyl isocyanurate and mixtures thereof. In one special embodiment the polyol used for preparing the polyester polyols is composed only of higher polyfunctional polyols having more than three hydroxyl groups. In another special embodiment the polyol mixture used for preparing the polyester polyols comprises at least one higher polyfunctional polyol having at least three hydroxyl groups, and at least one diol. Suitable diols are, for example, ethylene glycol, propylene glycol, butane-1,4-diol, pentane-1,5-diol, hexane-1,6-diol, neopentyl glycol, 2-butyl-2-ethylpropane-1,3-diol, diethylene glycol, dipropylene glycol, higher polyether diols, dimethylolcyclohexane, and mixtures of the aforementioned diols.

Polycarboxylic acids or their anhydrides that are suitable for preparing the polyester polyols are, for example, phthalic acid, phthalic anhydride, isophthalic acid, terephthalic acid, trimellitic acid, trimellitic anhydride, pyromellitic acid, pyromellitic dianhydride, tetrahydrophthalic acid, 1,2-, 1,3- or 1,4-cyclohexanedicarboxylic acid, 1,2-cyclohexanedicarboxylic anhydride, tricyclodecanedicarboxylic acid, succinic acid, glutaric acid, adipic acid, pimelic acid, suberic acid, azelaic acid, sebacic acid, maleic acid, maleic anhydride, fumaric acid, itaconic acid, mesaconic acid, citraconic acid, dimer fatty acids and mixtures thereof. In one preferred embodiment the polyester polyols used in the present invention are prepared using exclusively polycarboxylic acids of class 1 below. Class 1 is composed of phthalic acid, phthalic anhydride, isophthalic acid, terephthalic acid, trimellitic acid, trimellitic anhydride, pyromellitic acid, pyromellitic dianhydride, tetrahydrophthalic acid, tetrahydrophthalic anhydride, hexahydrophthalic acid, hexahydrophthalic anhydride and mixtures thereof.

In another preferred embodiment, the polyester polyols used in the present invention are prepared using at least 50% by weight, based on the total weight of the polycarboxylic acid component, of polycarboxylic acids or their anhydrides from class 1. According to this embodiment, the polycarboxylic acid component is composed to an extent of not more than 50% by weight, based on its total weight, of at least one polycarboxylic acid from class 2 below, consisting of succinic acid, glutaric acid, adipic acid, pimelic acid, suberic acid, azelaic acid, sebacic acid, dimer fatty acids and mixtures thereof. According to this embodiment, as well as at least one polycarboxylic acid of class 1 and optionally at least one polycarboxylic acid of class 2, the polycarboxylic acid component may additionally comprise up to a maximum of 10% by weight of at least one polycarboxylic acid from class 3, consisting of maleic acid, maleic anhydride, fumaric acid, itaconic acid, mesaconic acid, citraconic acid and mixtures thereof.

Suitable polyurethane polyols are known to the person of ordinary skill in the art, specifically through reaction of polyester polyol prepolymers—for example, including those of the aforementioned kind—with suitable di- or polyisocyanates, and are described in EP-A-1 273 640, for example.

Suitable polysiloxane polyols are described in WO-A-01/09260, for example, and the polysiloxane polyols recited therein are employed specifically in combination with other polyols, more particularly those having relatively high glass transition temperatures.

Where the coating material composition of the invention comprises further binders, as well as the binders which can be subsumed under the term of the polymeric polyols (a), these further binders may react with the other components of the coating material or else may be chemically inert with respect to them.

Preferred binders which dry physically, in other words being chemically inert toward the other coating-material constituents, are cellulose acetobutyrate (CAB), polyamides or polyvinyl butyral, for example.

The crosslinkers of component (b) may be blocked or nonblocked polyisocyanates. Specifically they are blocked or nonblocked aliphatic or cycloaliphatic polyisocyanates having at least two isocyanate groups in blocked or nonblocked form. On account of the yellowing tendency of the coatings produced with them, aromatic polyisocyanates are less suitable, although not excluded. With particular preference the polyisocyanates possess at least three free or blocked isocyanate groups. In coating compositions which are used in automotive OEM finishing it is typical to use blocked polyisocyanates. In automotive refinishing, it is preferred to use the polyisocyanates having free isocyanate groups that already undergo reaction at relatively low temperatures.

By “aliphatic nonblocked polyisocyanates” of component (b) are meant compounds having at least two free, specifically at least three free isocyanate groups in the molecule, these isocyanate groups being groups which are not blocked at room temperature (25° C.). The term encompasses dimers, trimers, and polymers of the aliphatic polyisocyanates as well. Examples thereof are dimers, trimers and polymers of hexamethylene diisocyanate (HDI), as for example its uretdiones and more particularly its isocyanurates.

Employed with very particular preference as aliphatic nonblocked polyisocyanates are the trimers of HDI, of the kind obtainable, for example, as Basonat HI 100 from BASF SE (Ludwigshafen, Germany), as Desmodur® N 3300 and Desmodur® XP 2410 from Bayer Material Science AG (Leverkusen, Germany), or as Tolonate® HDT and HDB from Perstorp AB in Perstorp, Sweden, and also similar products from Asahi Kasei Chemicals, Kawasaki, Japan, trade name Duranate® TLA, Duranate® TKA or Duranate® MHG.

The coating material of the invention may also comprise cycloaliphatic polyisocyanates, such as, more particularly, isophorone diisocyanate (IPDI) or cyclohexane(bis-alkyl isocyanate), and also their dimers, trimers and polymers.

As already mentioned above, in contrast, the use of aromatic polyisocyanates is less preferred, since coatings obtained from coating materials comprising aromatic polyisocyanates tend toward yellowing. In one particularly preferred embodiment of the invention, therefore, no aromatic polyisocyanates are used in the coating material.

The nonblocked polyisocyanates, however, may also be blocked, and then used as blocked polyisocyanates. Suitable blocking agents include more particularly those known from U.S. Pat. No. 4,444,954:
a) phenols such as phenol, cresol, xylenol, nitrophenol, chlorophenol, ethylphenol, tert-butylphenol, hydroxybenzoic acid, esters of this acid, or 2,5-di-tert-butyl-4-hydroxytoluene;
b) lactams, such as epsilon-caprolactam, delta-valerolactam, gamma-butyrolactam or beta-propiolactam;
c) active methylenic compounds, such as diethyl malonate, dimethyl malonate, ethyl or methyl acetoacetate or acetylacetone;
d) alcohols such as methanol, ethanol, n-propanol, isopropanol, n-butanol, isobutanol, tert-butanol, n-amyl alcohol, tert-amyl alcohol, lauryl alcohol, ethylene glycol monomethyl ether, ethylene glycol monoethyl ether, ethylene glycol monopropyl ether, ethylene glycol monobutyl ether, diethylene glycol monomethyl ether, diethylene glycol monoethyl ether, propylene glycol monomethyl ether, methoxymethanol, glycolic acid, glycolic esters, lactic acid, lactic esters, methylolurea, methylolmelamine, diacetone alcohol, ethylenechlorohydrin, ethylenebromohydrin, 1,3-dichloro-2-propanol, 1,4-cyclohexyldimethanol or acetocyanohydrin;
e) mercaptans such as butyl mercaptan, hexylmercaptan, tert-butyl mercaptan, tert-dodecyl mercaptan, 2-mercaptobenzothiazole, thiophenol, methylthiophenol or ethylthiophenol;
f) acid amides such as acetoanilide, acetoanisidinamide, acrylamide, methacrylamide, acetamide, stearamide or benzamide;
g) imides such as succinimide, phthalimide or maleimide;
h) amines such as diphenylamine, phenylnaphthylamine, xylidine, N-phenylxylidine, carbazole, aniline, naphthylamine, butylamine, dibutylamine or butylphenylamine;
i) imidazoles such as imidazole or 2-ethylimidazole;
j) ureas such as urea, thiourea, ethyleneurea, ethylenethiourea or 1,3-diphenylurea;
k) carbamates such as phenyl N-phenylcarbamate or 2-oxazolidone;
l) imines such as ethyleneimine;
m) oximes such as acetone oxime, formaldoxime, acetaldoxime, acetoxime, methyl ethyl ketoxime, diisobutyl ketoxime, diacetyl monoxime, benzophenone oxime or chlorohexanone oximes;
n) salts of sulfurous acid such as sodium bisulfite or potassium bisulfite;
o) hydroxamic esters such as benzyl methacrylohydroxamate (BMH) or allyl methacrylohydroxamate; or
p) substituted pyrazoles such as 3,5- or 3,4-dimethylpyrazole, or triazoles.

As crosslinking agents it is also possible to use amino resins, of the kind described, for example, in Römpp Lexikon Lacke and Druckfarben, Georg Thieme Verlag, 1998, page 29, “Aminoresins”, in the text book “Lackadditive” by Johan Bieleman, Wiley-VCH, Weinheim, New York, 1998, pages 242 ff., in the book “Paints, Coatings and Solvents”, second, fully revised edition, edited by D. Stoye and W. Freitag, Wiley-VCH, Weinheim, New York, 1998, pages 80 ff., in specifications U.S. Pat. No. 4,710,542 A1 or EP-B-0 245 700 A1, and also in the article by B. Singh and coworkers, “Carbamylmethylated Melamines, Novel Crosslinkers for the Coatings Industry”, in Advanced Organic Coatings Science and Technology Series, 1991, volume 13, pages 193 to 207.

Also possible for use, finally, as crosslinking agents are tris(alkoxycarbonylamino)triazine (TACT) and its derivatives. TACT and its derivatives are described in, for example, U.S. Pat. No. 5,084,541, U.S. Pat. No. 4,939,213, U.S. Pat. No. 5,288,865, U.S. Pat. No. 4,710,542 and in the EP applications EP-A-0565774, EP-A-0541966, EP-A-0604922 and EP-B-0245700. The specific additional use of these crosslinking agents produces particularly good chemicals resistance, which is manifested in particular in good results on outdoor weathering in accordance with the Jacksonville, Fla. test.

All of the crosslinking agents can be used alone or in combination with one another.

Where the coating material compositions are cured at temperatures above 100° C., such as 120 to 180° C., for example, it is preferred to use blocked polyisocyanates, amino resins and/or TACT and its derivatives. Aforesaid crosslinkers are therefore employed mostly in automotive OEM finishing. Where curing at room temperature (25° C.) to 100° C. or below is desired, then principally nonblocked polyisocyanates are used as crosslinking agents.

In minor amounts it is also possible to use crosslinkers different from the crosslinkers (b) identified above. Especially suitable in this context are those which enter into curing reactions with the binders within the same temperature range as the selected crosslinking agents. Examples of suitable such crosslinkers include components containing silyl groups, of the kind specified in WO 2008/074489, WO 2008/074490 and WO 2008/074491.

The glycerol diesters of the above-indicated formula (I) are obtainable by reaction of a compound of the general formula (II)

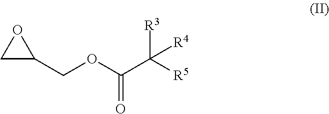

with a compound of the general formula (III)

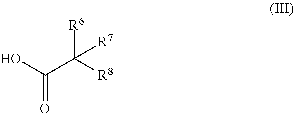

The reaction takes place by ring-opening addition of the COOH group of the compound of the formula (III) to the epoxy group of the compound of the formula (II).

The ring opening may take place with formation of a primary hydroxyl group or a secondary hydroxyl group. Where a primary hydroxyl group is obtained, in the compounds of the general formula (I) R¹=hydrogen and the radical R² is a radical of the formula O═C—C—C(R⁶)(R⁷)(R⁸). When a secondary hydroxyl group is obtained, in the compounds of the general formula (I) R²=hydrogen and R¹ is a radical of the formula O═C—C(R⁶)(R⁷)(R⁸).

The reaction product in general comprises mixtures of compounds of the general formula (I), where some of the products carry primary hydroxyl groups and the others have secondary hydroxyl groups. The ratio of primary to secondary hydroxyl groups can be influenced through the reaction conditions, more particularly the reaction temperature and the use of catalysts. Without use of a catalyst, the fraction of compounds having primary hydroxyl groups is generally predominant. Where, for example, ethyltriphenylphosphonium iodide is used as catalyst, the ratio of secondary to primary can be increased.

By controlling the ratio of primary to secondary hydroxyl groups it is possible to influence the reactivity of the glycerol diester (c) to a certain extent. Since compounds of the general formula (I) that contain primary hydroxyl groups generally react more quickly than those with secondary hydroxyl groups, it is possible, through the reaction regime when preparing the compounds of the general formula (I), to control their reactivity, with respect to isocyanate groups, for example. This advantageous flexibility in the process opens up the possibility of obtaining custom-tailored glycerol diesters and thus of influencing the pot life of the coating materials which comprise the glycerol diesters.

The compounds of the general formula (II) may be obtained, for example, by reacting epichlorohydrin with a carboxylic acid R³R⁴R⁵C—COOH as described in EP 1 115 714 B1 (example 1). One reaction product which can be used with particular preference and which falls within the general formula (II) is the glycidyl ester of Versatic® acid that is obtainable under the commercial designation Cardura® E10.

Carboxylic acids R³R⁴R⁵C—COOH and hence also carboxylic acids of the analogously defined general formula (III) are available commercially. Particularly preferred among them are the highly branched, saturated monocarboxylic acids that are known under the name Versatic® acids and have relatively long side chains and tertiary COOH groups, these acids being formed, for example, by Kochsche carboxylic acid synthesis from olefins, carbon monoxide and water. Especially preferred among these is neodecanoic acid. Other particularly preferred representatives are, for example, 2-propylheptanoic acid and isodecanoic acid.

The glycerol diesters can be prepared, for example, by introducing the compounds of the general formulae (II) and (III) into a solvent and heating this initial charge to a temperature in the range from 100 to 160° C. Where low-boiling solvents are used, the reaction may be carried out under elevated pressure. The progress of reaction is monitored by determination of the acid number. Examples of suitable solvents include aromatic hydrocarbons such as xylene, toluene, solvent naphtha, esters such as butyl acetate, pentyl acetate, ether esters such as methoxypropyl acetate and ethoxyethyl propionate, and ketones such as methyl ethyl ketone, methyl isoamyl ketone and methyl isobutyl ketone. The resulting glycerol diesters can then be used, where desired following (partial) removal of the solvent, in the coating material compositions of the invention.

The glycerol diesters, however, can also be formed in situ, in other words without being isolated, before or during the synthesis of the polymeric polyols (a), more particularly of the hydroxyl-containing poly(meth)acrylate. This can be done, for example, by introducing the compounds of the general formulae (II) and (III) into a suitable solvent, heating this initial charge to a temperature of, for example, 80 to 180° C., 160° C. for example, and subsequently metering in the catalysts and monomers that form the polymeric polyol (a). Suitable catalysts, where the polymeric polyol (a) is a hydroxyl-containing poly(meth)acrylate, include, for example, peroxide catalysts, such as di-tert-butyl peroxide (DTBP), for example. With this embodiment it is only possible to use monomer mixtures which contain only minor fractions (<10% by weight, based on the total weight of all the monomers) of acid-functional and/or epoxide-functional monomers. The reaction may be conducted under atmospheric pressure or superatmospheric pressure. Suitable solvents may be added to the reaction mixture before, during or after the polymerization in order on the one hand to influence the polymerization reaction and on the other hand to influence the resulting viscosity. Before, during or after the polymerization it is possible to add small amounts (0.01%-2.0% by weight, based on the total amount of the solid polymer) of a suitable reducing agent, in order to obtain particularly light-colored resin solutions. Reducing agents employed are specifically alkyl phosphites, and more specifically triisodecyl phosphite is used.

In one or more embodiments, the glycerol diester component (c) is present in the coating material compositions of the invention in an amount of 2% to 20% by weight, more specifically in an amount of 3% to 18% by weight, very specifically in an amount of 5% to 15% by weight, or better still 8% to 15% by weight, based on the total weight of components (a) and (c) in the coating material composition. Where the fraction of the glycerol diester component (c) is below 2% by weight, based on the total weight of components (a) plus (c), the effect according to the invention is usually small.

Where the fraction of the glycerol diester component (c) is above 20% by weight, based on the total weight of components (a) plus (c), then a frequent result is inadequately crosslinked films, which possess deficient resistant properties.

As well as the components (a), (b) and (c) which are mandatorily present in the coating material, it is possible, as already mentioned above, for the coating material to comprise further—different from these—crosslinkers, binders, reactive diluents or typical paint solvents.

Furthermore, the coating materials may also comprise further typical paint additives different from components (a), (b) and (c), such as, for example, catalysts which catalyze the crosslinking reaction(s), light stabilizers, preservatives, leveling additives, antisag agent (for example, those referred to as “Sag Control Agents”), wetting agents, matting agents, dyes, pigments or fillers.

In one or more embodiments, the coating material composition of the invention is a clearcoat material—that is, it is free or substantially free from nontransparent pigments and fillers. The coating material composition of the invention, however, may also be used as a primer-surfacer or basecoat material.

With particular preference the coating material composition of the invention is used as the uppermost paint coat in a multicoat paint system. With very particular preference it is applied as a clearcoat in automotive bodywork finishing.

The compositions of the invention may cure already at low temperatures (generally already below 100° C. such as 60° C., for example) chemically when these compositions comprise at least one crosslinker (b) which is reactive at these temperatures toward component (a) and/or (c), such as, for example, a nonblocked polyisocyanate. Compositions of this kind can be employed in automotive refinishing.

The use of blocked polyisocyanates, amino resin crosslinkers and/or TACT and/or its derivatives, in contrast, takes place customarily in automotive OEM finishing, where significantly higher curing temperatures prevail, such as, for example, 120 to 180° C., specifically 140 to 160° C.

In one or more embodiments, when free polyisocyanates are employed as crosslinkers (b), the coating material composition of the invention is prepared only shortly before its application, by mixing of the components, since a crosslinking reaction can take place even at room temperature between the free isocyanate groups of the aliphatic polyisocyanate (b) and the hydroxyl groups that are present in the polymeric polyol (a) and in the glycerol diester (c). There is generally no problem with preliminary mixing of the polymeric polyols (a) with the glycerol diester or diesters (c). In any case, the constituents of the coating material composition that are reactive with one another ought not to be mixed until shortly before the application of the coating material, in order to ensure a maximum processing life. In such a case the composition is referred to as a 2-component coating material (2C paint).

In automotive OEM finishing, the coating material compositions of the invention are provided as 1-component coating materials (1C paint). This means that the components do not react prematurely with one another—this is achieved by blocking of the isocyanate groups, for example.

Additionally provided by the present invention is a multicoat paint system which comprises at least two coats, specifically at least three coats. The coats are disposed on a primed or unprimed substrate, with the uppermost coat of the coats being formed from a coating material composition of the invention. If the substrate is primed, the primer is an electrodeposition primer, more particularly a cathodic electrodeposition primer. Priming may be preceded by a further pretreatment, more particularly a phosphatizing treatment.

Applied atop the primed or unprimed substrate there may be, for example, a conventional primer-surfacer coating material. Applied atop the primer-surfacer coating material—when the latter is present—there may be one or more basecoats. In the case of automotive refinishing, these may be purely physically drying basecoats or basecoats which cure thermally, by means of a crosslinker, or those which cure thermally and actinically, or actinically only, and, in automotive OEM finishing, more particularly, thermally crosslinking compositions. The possibility also exists of furnishing primer-surfacer coating materials with the properties of a basecoat or, conversely, of furnishing a basecoat with primer-surfacer properties, with the consequence that it may be sufficient to apply a primer-surfacer coat only or a basecoat only. Typically, a primer-surfacer coating material is applied as primer-surfacer coat, and at least one basecoat composition is applied as basecoat. Suitable primer-surfacer coating materials and basecoat composition include all commercial primer-surfacers or basecoat materials, more particularly those as are used in automotive OEM finishing or automotive refinishing. The last coat applied, finally, is a coating composition of the invention as a topcoat material, specifically as a transparent topcoat (clearcoat) material.

Further provided by the invention, accordingly, is a method for producing a multicoat paint system of the invention, comprising the following steps:
(i) applying a primer-surfacer coating material to an untreated or pretreated substrate and/or
(ii) applying at least one basecoat composition thereto and subsequently
(iii) applying at least one coating material composition of the invention, more particularly as a topcoat composition, specifically as clearcoat material, followed by
(iv) curing of the multicoat paint system at a temperature of up to 180° C. maximum, specifically at a temperature of
   (1) up to 100° C. maximum, where the crosslinking agent (b) is a nonblocked polyisocyanate, or
   (2) from 120° C. to 180° C., where the crosslinking agent (b) comprises at least one blocked polyisocyanate, an amino resin crosslinker or TACT.

In one particular embodiment, the substrate in step (i) is a pretreated metallic substrate and the pretreatment comprises a phosphatizing and/or cathodic electrocoating procedure. In another particular embodiment, the substrate in step (i) is a plastics substrate.

In a further embodiment of the method of the invention for producing a multicoat paint system, step (iii) is carried out using a coating composition of the invention that comprises as component (a) at least one poly(meth)acrylate polyol or polyester polyol.

In a further embodiment of the method of the invention for producing a multicoat paint system, step (iii) is carried out using a coating composition which is a clearcoat material.

As primer-surfacer coating materials and basecoat composition it is possible to use conventional materials, i.e. commercial primer-surfacers and basecoat materials. Especially suitable are those as used in automotive OEM finishing and automotive refinishing.

The individual coats are applied in accordance with the customary coating processes familiar to a person of ordinary skill in the art. The compositions and coating materials in steps (i), (ii) and (iii) are applied specifically by spraying, pneumatically and/or electrostatically.

Steps (i), (ii) and (iii) take place specifically wet-on-wet. Prior to the application of the basecoat composition or basecoat compositions, the primer-surfacer may only be flashed off at room temperature, or else may be dried at an elevated temperature of specifically not more than 100° C., more specifically 30 to 80° C. and very specifically 40 to 60° C. Drying may also take place by IR irradiation.

The comments made for the primer-surfacer coating with respect to flashing off and/or drying, and the relevant drying temperatures, apply equally to the basecoat or basecoats.

Instead of wet-on-wet application, another possibility is that of curing of the primer-surfacer and/or basecoat film(s) before the coat is applied in step (iii). The conventional primer-surfacers and/or basecoat materials can typically be cured thermally, with actinic radiation, or with a combination of thermal and actinic radiation curing.

The curing of the coating material composition of the invention applied in step (iii) takes place at temperatures up to 180° C. maximum, more specifically at temperatures from room temperature to 160° C. maximum, and very specifically at temperatures from 140° C. to 160° C. for automotive OEM finishing. For automotive refinishing the curing is carried out commonly at room temperature (25° C.) to 80° C., specifically at up to 60° C. maximum. The curing may also be preceded by flashing off.

Additionally provided by the present invention is a substrate applied on which is a multicoat paint system of the invention.

Suitable substrate materials include, in particular, metallic substrates, such as, for example, automotive bodywork or automotive bodywork parts, but also plastics substrates, of the kind used in particular in 2-component OEM finishing of plastics parts.

In the text below the intention is to illustrate the invention using examples.

### EXAMPLES

The experiments below were carried out using reagents and solvents in technical purity from various manufacturers. Cardura® E10 and Versatic acid were acquired from Hexion (Louvain-la-Neuve, Belgium). The size exclusion GPC was carried out using the Isocratic Mode Pump Waters 515 and the columns HR5E (linear) and HR2 (500) in series (from Waters, Eschborn, Germany and PSS Polymer Standard Services, Mainz, Germany). The polystyrene standard used was Calibration Polystyrene PS2 from Polymer Laboratories (Darmstadt, Germany) (580 to 377400 Da). The Gardner viscosity was determined using Standard Gardner Tubes (from Byk Gardner, Geretsried, Germany), and the Brookfield viscosity using the CAP 2000 instrument (Brookfield E.L.V. GmbH, Lorch, Germany). DOI measurements were carried out using the Wave-Scan DOI 4816 instrument from Byk Gardner (Geretsried, Germany).

### Example 1

### Preparation of an Inventively Useful Glycerol Diester

A 5 liter reaction vessel equipped with a mechanical stirrer and reflux condenser was charged with 1241.1 g (7.25 mol) of Versatic acid and 1758.9 g (7.10 mol) of Cardura® E10. Heating took place to 150° C. at a stirring speed of 150 revolutions per minute. The reaction progress was monitored by determination of the acid number. After about an hour, the reaction was at a complete conclusion. 3000 g of a clear, pale yellowish liquid were obtained. The Gardner viscosity was I-K. The Brookfield viscosity (Cone Plate 3, 200 revolutions per minute, 23° C.) was about 325 mPas. The acid number was about 5 mg KOH/g. The color number (APHA) was 40. The number-average and weight-average molecular weights were determined by GPC against a polystyrene standard, using a refractive index detector, and were as follows: M_{w}:450 daltons and Mₙ:430 daltons. The ratio of primary OH groups to secondary OH groups in the target product was 1:1.27 (determined by means of ¹H NMR). This means that there was a mixture of two glycerol diesters present (according to the above definition, the fraction of compounds with R¹=H was 44% and the fraction of compounds with R²=H was 56%).

### Example 2

### Preparation of an Inventively Useful Glycerol Diester (In Situ)

First of all the reaction vessel, equipped with stirrer, internal thermometer, 2 dropping funnels and inert gas supply, was charged with a mixture of Cardura® E10 [CAS 26761-45-5], Versatic acid [CAS 26896-20-8] and solvent naphtha, and heating took place to 156° C. with stirring.

Subsequently at 156° C., simultaneously over a period of 4 hours, a solution of di-tert-butyl peroxide in solvent naphtha and also a mixture of methyl methacrylate, styrene, acrylic acid and hydroxyethyl methacrylate were metered in. Thereafter, over a period of a further 30 minutes at 156° C., a further solution of di-tert-butyl peroxide in solvent naphtha was added, in order to ensure complete reaction of the monomers. The reaction mixture was cooled and diluted with solvent naphtha and butyl acetate to a solids of 54.8% (1 g was dried at 110° C. for 1 hour). The hydroxy-functional poly(meth)acrylate obtained possesses an acid number of 10.8 mg KOH/g, a calculated hydroxyl number of 140 mg KOH/g, a number-average molecular weight Mₙ of 3701 g/mol (determined by means of gel permeation chromatography (GPC) against a polystyrene standard) and a weight-average molecular weight M_{w} of 6916 g/mol (determined by means of GPC against a polystyrene standard).

### Example 3

### Preparation of a Hydroxy-Functional Poly(meth)acrylate

The procedure of example 2 was repeated, except that the step of reaction of Cardura® E10 [CAS 26761-45-5] with Versatic acid [CAS 26896-20-8] in solvent naphtha at 156° C. was omitted without replacement.

The reaction mixture was cooled and diluted with solvent naphtha to a solids of 53.8% (1 g was dried at 110° C. for 1 hour). The hydroxy-functional poly(meth)acrylate obtained possesses an acid number of 10.1 mg KOH/g, a hydroxyl number of 138 mg KOH/g, a number-average molecular weight Mₙ of 4277 g/mol (determined by means of gel permeation chromatography (GPC) against a polystyrene standard) and a weight-average molecular weight M_{w} of 7018 g/mol (determined by means of GPC against a polystyrene standard).

### Use Examples 1 (Comparative) and 1A (Inventive)

TABLE 1

| | Use example 1 | Use example 1A |
|---|---|---|
| | (parts byweight) | (parts by weight) |
| Composition from | 38.72 | |
| example 3 | | |
| Composition from | | 40.72 |
| example 2 | | |
| Polyacrylate-based | 15.49 | 15.49 |
| rheological assistant | | |
| (60% strength in solvent | | |
| naphtha/butyl acetate) | | |
| Curing agent mixture | 10.0 | 10.0 |
| based on melamine resin | | |
| (75% strength in butanol) | | |
| UV protectant | 0.18 | 0.18 |
| Additive solution based | 5.93 | 5.93 |
| on modified polysiloxanes | | |
| Surface-active agent | 0.3 | 0.3 |
| Methyl amyl ketone | 0.85 | 0.85 |
| Xylene | 13.15 | 16.03 |
| Butyl alcohol | 3.31 | 3.31 |
| Butyl glycol acetate | 2.0 | 2.0 |
| Butyl diglycol acetate | 4.5 | 4.5 |
| Viscosity, DIN 4 cup, | 27″ | 27″ |
| 23° C., in seconds | | |
| Solids (2 g, 90 min. at 165° C.) | 43.2 | 44.5 |
| in % | | |

### Production and Testing of the Coatings

The overall visual appearance was assessed after electrostatic ESTA BOL application of the coating materials over a commercial aqueous basecoat (black solid-color) from BASF Coatings GmbH or over a commercial aqueous basecoat silver metallic from BASF Coatings GmbH. Thereafter the resulting coating in each case is flashed off at room temperature for 5 minutes and subsequently baked at 140° C. for 22 minutes.

The baked paint films were analyzed using the Wave Scan instrument from Byk Gardner, with 1250 measurement points being recorded over a distance of 10 cm. The instrument divides the reflection into a long wave (LW) component, i.e. the variance in light intensity for structures in the range from 0.6 mm to 10 mm, and a short wave (SW) component, i.e. the variance in light intensity for structures in the range from 0.1 mm to 0.6 mm.

TABLE 2

| | | Thickness | Long | Short | Distinctiveness of |
|---|---|---|---|---|---|
| | Exp. | (μm) | Wave | Wave | Image (DOI) |
| Use example 1 | I | 42 | 3 | 6 | 84.5 |
| Use example 1A | II | 32 | 4 | 5 | 84.4 |
| Use example 1 | III | 32 | 8 | 7 | 83.7 |

The performance data set out in table 2 show that the coating material composition of the invention, as per use example 1A, which has a coating thickness (32 micrometers) which is lower by around 20% (corresponding to experiment II), yields approximately equal values for appearance (Long Wave, Short Wave and “Distinctiveness of Image” (DOI)) to those of a coating material composition which contains no glycerol diester (use example 2; as per experiment I). Experiment III represents a repetition of experiment I, but with a film thickness of 32 micrometers. The appearance is significantly poorer than for the inventive example (experiment II).

1. A coating material composition comprising
(a) at least one polymeric polyol selected from the group consisting of poly(meth)acrylate polyols, polyester polyols, polyurethane polyols and polysiloxane polyols,
(b) at least one crosslinking agent selected from the group consisting of blocked and nonblocked polyisocyanates, amino resin crosslinkers, and TACT, and
(c) at least one glycerol diester of the general formula (I) 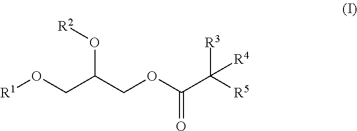
wherein
one of the two radicals R¹ or R² is hydrogen and the radical of the two radicals R¹ and R² that is not hydrogen is a radical 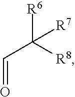
and
the radicals R³, R⁴, R⁵, R⁶, R⁷ and R⁸ independently of one another are hydrogen or a saturated, aliphatic radical having 1 to 20 carbon atoms, with the proviso that the radicals R³, R⁴ and R⁵ together contain at least 5 carbon atoms and the radicals R⁶, R⁷ and R⁸ together contain at least 5 carbon atoms.

2. The coating material composition of claim 1, wherein R¹ is hydrogen.

3. The coating material composition of claim 1, wherein R² is hydrogen.

4. The coating material composition of claim 1, wherein the radicals R³, R⁴ and R⁵ together contain 5 to 11 carbon atoms and the radicals R⁶, R⁷ and R⁸ together contain 5 to 11 carbon atoms.

5. The coating material composition of claim 1, wherein component (a) comprises at least one poly(meth)acrylate polyol or polyester polyol.

6. The coating material composition of claim 1, wherein component (b) comprises at least one blocked or nonblocked polyisocyanate.

7. The coating material composition of claim 1, wherein the coating material composition is a clearcoat material.

8. The coating material composition of claim 1, wherein the hydroxyl number of component (a) differs by not more than 50% from the hydroxyl number of the glycerol diester component (c) used in the coating material composition, and/or the fraction of the glycerol diester component (c) is 2% to 20% by weight, based on the total weight of components (a) plus (c).

9. A multicoat paint system comprising at least two coats disposed on a substrate, wherein the uppermost coat of the coats consists of the coating material composition of claim 1.

10. A method for producing a multicoat paint system, comprising the following steps:
(i) applying a primer-surfacer coating material to an untreated or pretreated substrate and/or
(ii) applying at least one basecoat composition thereto and subsequently
(iii) applying at least one coating composition according to claim 1, followed by
(iv) curing of the multicoat paint system at a temperature of
(1) up to 100° C. maximum, where the crosslinking agent (b) is a nonblocked polyisocyanate, or
(2) from 120° C. to 180° C., where the crosslinking agent (b) comprises at least one blocked polyisocyanate, an amino resin crosslinker or TACT.

11. The method for producing a multicoat paint system of claim 10, wherein the substrate in step (i) is a pretreated metallic substrate and the pretreatment comprises a phosphatizing and/or cathodic electrode position coating treatment or the substrate in step (i) is a plastics substrate.

12. The method for producing a multicoat paint system of claim 10, wherein in step (iii) a coating composition comprising (a) at least one polymeric polyol selected from the group consisting of poly(meth)acrylate polyol or polyester poly, (b) at least one crosslinking agent selected from the group consisting of blocked and nonblocked polyisocyanates, amino resin crosslinkers, and TACT, and (c) at least one glycerol diester of the general formula (I) 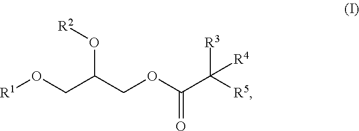
wherein one of the two radicals R¹ or R² is hydrogen and the radical of the two radicals
R¹ and R² that is not hydrogen is a radical 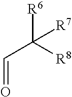
and the radicals R³, R⁴, R⁵, R⁶, R⁷ and R⁸ independently of one another are hydrogen or a saturated, aliphatic radical having 1 to 20 carbon atoms, with the proviso that the radicals R³, R⁴ and R⁵ together contain at least 5 carbon atoms and the radicals R⁶, R⁷ and R⁸ together contain at least 5 carbon atoms is used.

13. The method for producing a multicoat paint system claim 10, wherein in step (iii) a clearcoat coating composition comprising comprising (a) at least one polymeric polyol selected from the group consisting of poly(meth)acrylate polyol or polyester poly, (b) at least one crosslinking agent selected from the group consisting of blocked and nonblocked polyisocyanates, amino resin crosslinkers, and TACT, and (c) at least one glycerol diester of the general formula (I) 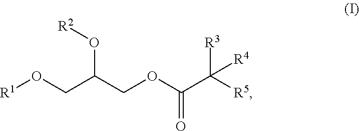
wherein one of the two radicals R¹ or R² is hydrogen and the radical of the two radicals R¹ and R² that is not hydrogen is a radical 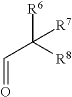
and the radicals R³, R⁴, R⁵, R⁶, R⁷ and R⁸ independently of one another are hydrogen or a saturated, aliphatic radical having 1 to 20 carbon atoms, with the proviso that the radicals R³, R⁴ and R⁵ together contain at least 5 carbon atoms and the radicals R⁶, R⁷ and R⁸ together contain at least 5 carbon atoms is used.

14. The method for producing a multicoat paint system of claim 10, wherein the substrate in step (i) is an automotive bodywork or a part of an automotive bodywork.

15. A substrate that has been coated with the multicoat paint system of claim 9.

16. A substrate that has been coated by the method of claim 10.
